(19) United States
(12) Patent Application Publication
(10) Pub. No.: US 2002/0095253 A1
(43) Pub. Date: Jul. 18, 2002

(54) Vehicle stability control system with tire sensor assembly

(75) Inventors: Allan Losey, Ortonville, MI (US); David Ladd, Lake Orion, MI (US)

Correspondence Address: LAURA M. SLENZAK, SIEMENS CORPORATION, 186 WOOD AVENUE SOUTH, ISELIN, NJ, 08830, US

(73) Assignee: Siemens VDO Automotive Corporation

(21) Appl. No.: 10/050,391

(22) Filed: Jan. 16, 2002

Related U.S. Application Data
(60) Provisional application No. 60/262,230, filed on Jan. 16, 2001.

(51) Int. Cl. G06F 17/00

(52) U.S. Cl. 701/71; 701/82

(57) ABSTRACT

A vehicle control system 10 uses tire characteristic information such as tire pressure and temperature for vehicle systems such as anti-lock brake systems (ABS) 28, traction control systems 30, and stability control systems 32. Variances in tire temperature and pressure can affect the tire radius dimension, which is used to calculate vehicle speed and individual tire rotation speed. This speed data is the basic foundation for generating control output signals for ABS 28, traction 30, and stability 32 control systems. The control system includes sensors 14 for measuring tire pressure and temperature during vehicle operation to modify output control signals for the ABS 28, traction 30, and stability control 32 systems.

### CROSS-REFERENCE TO RELATED APPLICATIONS

The application claims priority to U.S. Provisional Application No. 60/262,230, which was filed on Jan. 16, 2001.

### BACKGROUND OF THE INVENTION

This invention relates to a system that generates tire characteristic input data that can be used in various vehicle control systems.

Anti-lock brake systems (ABS), traction control systems, and stability control systems are used on vehicles to optimize vehicle performance and safety. These systems measure vehicle speed and individual wheel speed and base output control signals on these measurements. The systems use a tire radius dimension to calculate the wheel speed at each of the vehicle wheels and to calculate the overall vehicle speed. The tire radius dimension is programmed into the system based on the type of tire on the vehicle and the optimal operating tire pressure.

Changes in tire pressure and tire temperature can vary the tire radius dimension.

For example, a tire with low pressure will have a smaller tire radius. Thus, the ABS and traction control and stability control systems will be calculating wheel and vehicle speed based on a tire radius dimension that is different than the actual tire radius.

Some vehicles have tire pressure monitoring systems but, traditionally these systems measure tire pressure and indicate to the vehicle operator when the tire pressure falls below or exceeds a predetermined optimal operating tire pressure. There is no communication of any tire characteristic to the various control systems.

Thus, it is desirable to have a system that uses tire characteristic data measured during vehicle operation to increase the accuracy of ABS, traction control, and stability control systems, as well as overcoming the other above mentioned deficiencies with the prior art.

### SUMMARY OF THE INVENTION

A vehicle control system includes a sensor assembly for monitoring tire characteristics. Tire characteristic data is transmitted to a controller that uses the data for generating output control signals for various vehicle systems such as anti-lock brake systems (ABS), traction control systems, and stability control systems.

In the preferred embodiment, the sensor assembly includes a sensor component for measuring tire pressure. The sensor generates a tire pressure signal, which is transmitted to the controller. The controller modifies the output control signals for the ABS and traction control and/or stability control systems based on the tire pressure signal.

Additionally, the sensor assembly can include a sensor component for measuring tire temperature. The sensor component generates a tire temperature signal that is transmitted to the controller. The controller modifies the output control signals for the ABS and traction control and/or stability control systems based on the tire temperature signal.

The subject system increases accuracy and optimizes vehicle performance and safety. These and other features of the present invention can be best understood from the following specifications and drawings, the following of which is a brief description.

### BRIEF DESCRIPTION OF THE DRAWINGS

FIG. 1 is a schematic diagram of a vehicle control system incorporating the subject invention.

### DETAILED DESCRIPTION OF A PREFERRED EMBODIMENT

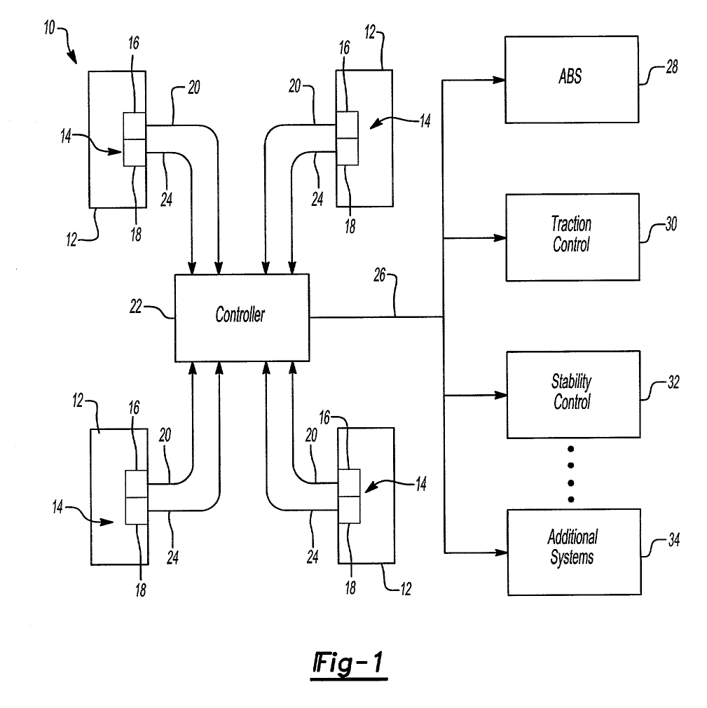

A vehicle with a control system is generally indicated at 10 in FIG. 1. The vehicle includes a plurality of tires 12 that are mounted for rotation with vehicle wheels (not shown). Each tire 12 includes a sensor assembly 14 that measures at least one tire characteristic.

The sensor assembly 14 preferably includes a first sensor component 16 for measuring tire pressure at each tire 12 and a second sensor component 18 for measuring tire temperature at each tire. The first sensor component 16 generates a tire pressure signal 20 that is transmitted to a processor or controller 22. The second sensor component 18 generates a tire temperature signal 24 that is transmitted to the controller 22. The controller 22 can be any type of microprocessor or similar computational device known in the art and can be configured as a single central controller or a plurality of controllers.

The controller 22 generates an output control signal 26 that is transmitted to various vehicle subsystems. The controller 22 uses the information supplied by the tire pressure 20 and tire temperature signals 24 to modify control signals for vehicle subsystems such as an anti-lock brake system 28, a traction control system 30, a stability control system 32, or other vehicle control subsystems 34. The operation of these ABS 28, traction control 30, and stability control 32 systems are well known in the art and will not be discussed in detail.

The ABS 28, traction control 30, and stability control 32 systems use the tire radius dimension to calculate the wheel speed at each of the vehicle wheels and to calculate the overall vehicle speed. Changes in tire pressure and tire temperature, resulting in the tire being over or under inflated, varies the tire radius dimension. For example, a tire with low pressure will have a smaller tire radius than a tire having a higher tire pressure. The controller 22 uses the data from the tire pressure 20 and tire temperature signals 24 to determine the actual tire radius during vehicle operation. Thus, the ABS 28, traction control 30, and stability control 32 systems will have more accurate wheel and vehicle speed calculations when the actual tire radius information is used.

The controller 22 can also use tire pressure and temperature information as expected inputs for the ABS, traction control, and stability control system algorithms.

For example, an extremely cold, over inflated tire will have a lower coefficient of friction than a warm, properly inflated tire. The controller 22 can use the tire pressure and temperature data to generate optimal control signals 26 for the ABS 28, traction control 30, and stability control 32 systems to account for these temperature and pressure differentials that occur during vehicle operation. Further, the vehicle can include a sensing device for monitoring ambient temperature. The ambient temperature information can be used to indicate possible icy road conditions.

Also, as another example, over inflated tires affect the rollover stability of a vehicle. The control signal to the stability control system 32 is preferably modified or optimized by the controller 22 when an over inflated tire is identified.

The sensor assemblies 14 can continuously monitor tire characteristics during vehicle operation or can intermittently measure the tire characteristics during vehicle operation at predetermined intervals. Further, it should be understood that the sensor assembly 14 can include additional sensor components for monitoring other tire characteristics or can utilize only one of the sensor components 16, 18.

The system could also include a sensor or other similar device to identify a spare tire that has been installed on the vehicle to replace a flat tire. Typically, a spare tire is smaller than a factory installed tire and thus, the tire radius is smaller. The controller 22 uses the spare tire radius information to adjust speed control for the ABS 28, traction control 30, and stability control 32 systems.

The system could also use other vehicle information in combination with the tire information to modify system control signals. For example, the vehicle could include brake temperature sensors for monitoring brake temperature. An increase in brake temperature over a predetermined level could indicate either a hot tire resulting from operating at a non-optimal tire pressure, a hot brake approaching a brake fade condition, or a hot wheel bearing. By measuring tire pressure and brake temperature the controller 22 can use the information to modify the control signal to the ABS 28, traction control 30, and/or stability control 32 systems.

Vehicle loading information can also optionally be used to modify vehicle control signals. The system can include a load sensor mounted to a vehicle chassis for monitoring vehicle load. Optimal tire pressure can vary for an unloaded to a loaded condition on a vehicle. The controller 22 can use information from the tire pressure and load sensors to modify control signals for the ABS 28, traction control 30, and stability control 32 systems as well as using the information to determine or recommend an optimal tire pressure.

A transponder device can optionally be embedded in the tire with a continuous loop antennae. The transponder device provides traceability for every tire based on a unique transponder code. The information can be used for installation purposes, recall, disposability purposes, warranty purposes, etc. Once the controller 22 identifies the tire based on the code, the information can be cross-referenced with stored data to determine optimal tire pressures.

The system can also use the tire pressure information for diagnostic purposes. For example, if a wheel speed sensor in the ABS system 38 stops generating a signal but the system is still generating a tire pressure signal then the tire pressure information can be used as a double check. Also, if information in the stability 32 or traction control 30 systems tends to indicate there might be system sensor drift on yaw or steering angle, the controller 22 might not need to compensate if a low pressure tire has been identified.

The system could also include a recorder device, similar to an airplane flight recorder, which gathers data from tires and other vehicle systems for accident reconstruction purposes. The flight recorder records during normal operation through the end of the crash, i.e. the recorder records pre-crash information, post-crash information, and information generated during the crash. A crash can be detected or determined by any one of a number of factors such as detecting a signal to inflate the air bags, detecting extremely rapid deceleration of the vehicle, measuring seat belt tension, measuring position of the occupant, sensing a roll-over condition, or sensing any other abnormal vehicle event. Detecting an airbag deploy signal, roll-over warning signal, or other signal indicating an abnormal vehicle event may be done by monitoring the vehicle bus, for example. Detecting rapid deceleration may be done by using information from the ABS system 28 or by independently monitoring vehicle speed. Changes in occupant position can be determined by using seat sensor information indicating sudden changes in weight distribution on the seat or by using optical sensors such as a camera indicating an occupant rapidly lurching forward, for example. The stored information for the tire should be pre-crash information to accommodate tire blowouts.

The subject control system 10 increases accuracy and optimizes vehicle performance and safety. Although a preferred embodiment of this invention has been disclosed, a worker of ordinary skill in this art would recognize that certain modifications would come within the scope of this invention. For that reason, the following claims should be studied to determine the true scope and content of this invention.

1. A vehicle control system comprising:
at least one tire having at least one tire characteristic that varies tire radius during vehicle operation;
a sensor assembly for measuring said tire characteristic and generating a tire characteristic signal; and
a controller for receiving said tire characteristic signal and modifying a control system output signal based on said tire characteristic.

2. A system according to claim 1 wherein said tire characteristic is tire pressure.

3. A system according to claim 1 wherein said tire characteristic is tire temperature.

4. A system according to claim 1 wherein said at least one tire characteristic comprises a plurality of tire characteristics that vary said tire radius during vehicle operation including a tire pressure characteristic and a tire temperature characteristic.

5. A system according to claim 4 wherein said sensor assembly includes a first sensor component for measuring tire pressure and generating a tire pressure signal and a second sensor component for measuring tire temperature and generating a tire temperature signal.

6. A system according to claim 1 wherein said at least one tire comprises a plurality of tires each having one of said sensor assemblies.

7. A system according to claim 1 wherein said control system output signal is transmitted to an anti-lock braking system.

8. A system according to claim 1 wherein said control system output signal is transmitted to a traction control system.

9. A system according to claim 1 wherein said control system output signal is transmitted to a stability control system.

10. A vehicle control system comprising:
a plurality of tires;
a pressure sensor assembly for measuring tire pressure and generating a tire pressure signal for each of said tires;
a controller that receives said tire pressure signals and modifies a control system output signal based on measured tire pressure at each of said tires.

11. A system according to claim 10 wherein said control system output signal is transmitted to a plurality of vehicle control subsystems.

12. A system according to claim 11 wherein said control subsystems include an antilock brake system, a traction control system, and a stability control system.

13. A system according to claim 11 including a temperature sensor assembly for measuring tire temperature and generating a tire temperature signal for each of said tires, said tire temperature signals being transmitted to said controller for modifying said output signal based on measured tire temperature at each of said tires.

14. A method for controlling a vehicle system comprising the steps of:
(a) measuring at least one tire characteristic;
(b) generating a tire characteristic signal based on the measurement of step (a);
(c) modifying a control system output signal in response to the tire characteristic signal.

15. A method according to claim 14 wherein step (a) includes continuously measuring the tire characteristic during vehicle operation.

16. A method according to claim 14 wherein step (a) includes intermittently measuring the tire characteristic during vehicle operation.

17. A method according to claim 14 wherein the tire characteristic is tire pressure.

18. A method according to claim 14 wherein the tire characteristic is tire temperature.

19. A method according to claim 14 wherein step (a) is further defined as measuring multiple tire characteristics including tire pressure and tire temperature and wherein step (b) is further defined as generating a tire pressure signal based on measured tire pressure and generating a tire temperature signal based on measured tire temperature and wherein step (c) is further defined as modifying the control system output signal based on the tire pressure and temperature signals.

20. A method according to claim 14 including the step of transmitting the control system output signal to at least one of a anti-lock braking system, a traction control system, or a stability control system.
